(19) United States
(12) Patent Application Publication
(10) Pub. No.: US 2010/0269614 A1
(43) Pub. Date: Oct. 28, 2010

(54) DECELERATION DEVICE FOR POWER TURRET CLUTCH

(76) Inventor: Fu-Hsiang TUNG, Bulimba QLD (AU)

Correspondence Address: Ching-Ling Huang, 5597 NW 127th Ter, Portland, OR, 97229, US

(21) Appl. No.: 12/428,470

(22) Filed: Apr. 22, 2009

(51) Int. Cl. F16H 61/00

(52) U.S. Cl. 74/335

(57) ABSTRACT

A deceleration device for a power turret clutch, which outputs dynamic power to a spindle connector, comprises a deceleration gear assembly, a slide gear shaft, a displacement driving unit, and a transmission spindle. The displacement driving unit and the transmission spindle respectively drive the slide gear shaft to slide axially and rotate, whereby the slide gear shaft can supply dynamic power. The slide gear shaft has a gear. The gear engages with the deceleration gear assembly or the spindle connector according to the position the slide gear shaft slides to. According to whether the slide gear shaft engages with the deceleration gear assembly or the spindle connector, one of two rotation speeds is selected to output dynamic power via the single transmission spindle.

### FIELD OF THE INVENTION

The present invention relates to a deceleration device for a power turret clutch, particularly to using a single transmission shaft to output two types of dynamic power having different rotation speeds respectively driving different mechanical units.

### BACKGROUND OF THE INVENTION

In a multi-functional machine, a machine is equipped with a plurality of cutting seats accommodating different types of cutting tools, and the cutting tools can be automatically shifted to perform required machining.

In the conventional multi-functional machines, two motors respectively supply dynamic power to rotate the principal shaft and shift the cutting seats. Thus, the conventional multi-functional machines are usually bulky and expensive. However, the current trend is toward miniaturizing the multi-functional machines.

### SUMMARY OF THE INVENTION

The primary objective of the present invention is to utilize a single dynamic power to support the rotation of the principal shaft and the shifting of the cutting seats.

To achieve the abovementioned objective, the present invention proposes a deceleration device for a power turret clutch, which comprises a deceleration gear assembly, a slide gear shaft, a displacement driving unit, and a transmission spindle, wherein the slide gear shaft has a gear, and the displacement driving unit drives the slide gear shaft to slide axially and reach a first position and a second position. When sliding to the first position, the slide gear shaft engages with a spindle connector. When sliding to the second position, the slide gear shaft disengages with the spindle connector and engages with the deceleration gear assembly. The transmission spindle drives the slide gear shaft to rotate and supplies dynamic power to the slide gear shaft.

The present invention is characterized in that a single transmission spindle provides dynamic power for the rotation of the shaft and the shifting of the cutting seats. Therefore, the present invention can greatly reduce the volume and cost of a multi-functional machine.

### BRIEF DESCRIPTION OF THE DRAWINGS

FIG. 1 is a perspective view schematically showing the appearance of a deceleration device for a power turret clutch according to the present invention;

FIG. 2A is a sectional view schematically showing the structure of a deceleration device for a power turret clutch according to the present invention;

FIG. 2B is another sectional view schematically showing the structure of a deceleration device for a power turret clutch according to the present invention;

FIG. 3 is a sectional view schematically showing a first engagement mechanism of the transmission spindle and the slide gear shaft according to the present invention;

FIG. 4 is a sectional view schematically showing a second engagement mechanism of the transmission spindle and the slide gear shaft according to the present invention;

FIG. 5 is a sectional view schematically showing a third engagement mechanism of the transmission spindle and the slide gear shaft according to the present invention;

FIG. 6 is a perspective view schematically showing the appearance of a rotational wheel device according to the present invention;

FIG. 7 is a sectional view schematically showing the structure of a rotational wheel device according to the present invention;

FIG. 8 is a perspective view schematically showing the appearance of a spindle connector according to the present invention;

FIG. 9A is a sectional view schematically showing the structure of a spindle connector according to the present invention;

FIG. 9B is a sectional view schematically showing the operation of a spindle connector according to the present invention;

FIG. 10 is a perspective view schematically showing that cutting tools are mounted on a deceleration device for a power turret clutch according to the present invention;

FIG. 11 is a sectional view schematically showing that cutting tools are mounted on a deceleration device for a power turret clutch according to the present invention; and

FIG. 12 is a partial exploded view schematically showing that cutting tools are mounted on a deceleration device for a power turret clutch according to the present invention.

### DETAILED DESCRIPTION OF THE PREFERRED EMBODIMENTS

Below, technical contents of the present invention are described in detail with the embodiments. However, it should be understood that the embodiments are only to exemplify the present invention but not to limit the scope of the present invention.

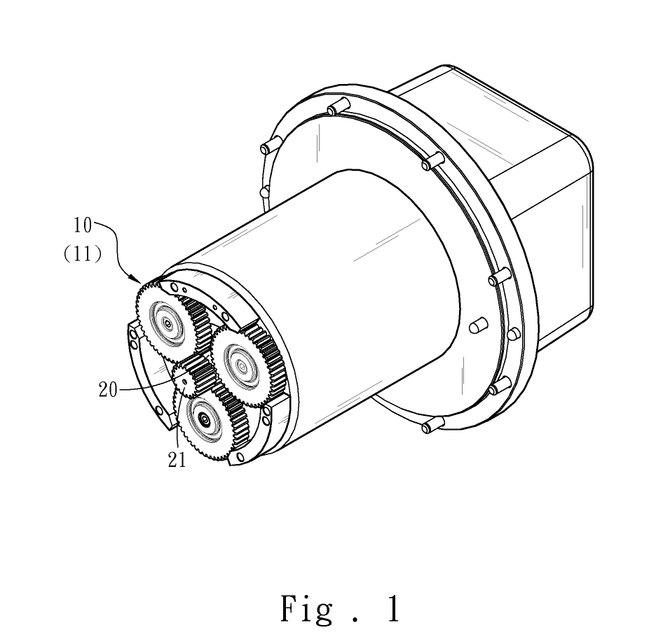

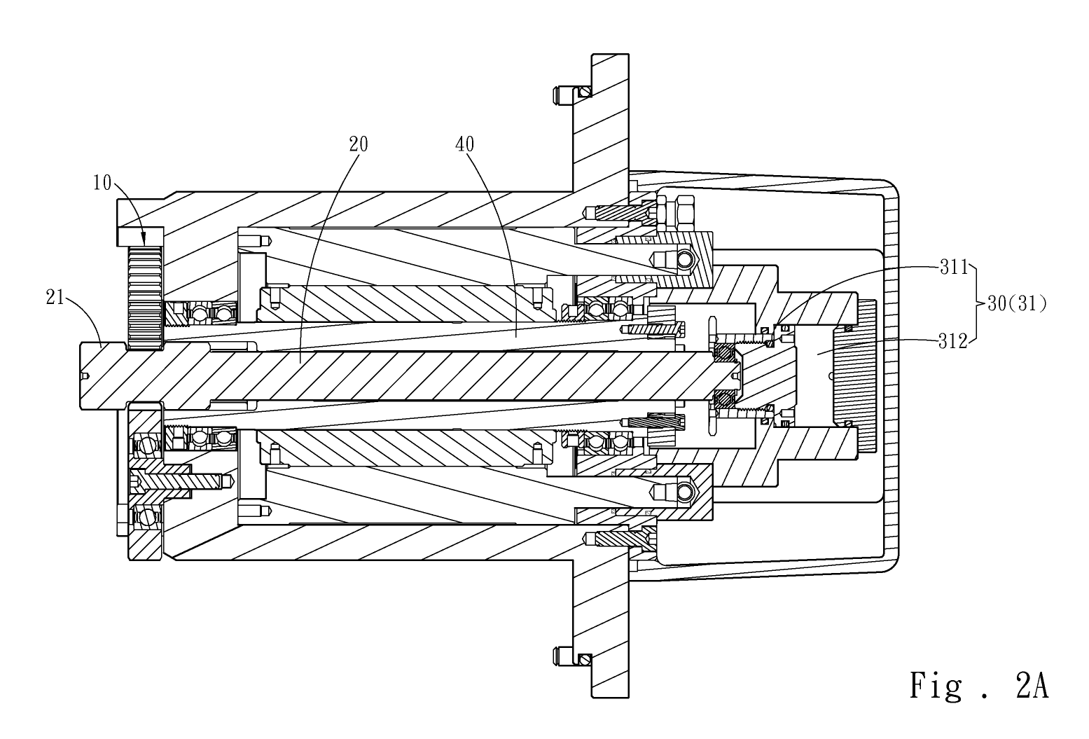

Refer to FIG. 1, FIG. 2A and FIG. 2B. The deceleration device for a power turret clutch of the present invention comprises a deceleration gear assembly 10, a slide gear shaft 20, a displacement driving unit 30, and a transmission spindle 40. The slide gear shaft 20 has a gear 21, and the displacement driving unit 30 drives the slide gear shaft 20 to slide axially and reach a first position (as shown in FIG. 2A) and a second position (as shown in FIG. 2B). The displacement driving unit 30 is a hydraulic unit 31 having a first chamber 311 and a second chamber 312. When liquid is respectively injected into the first chamber 311 and the second chamber 312, the slide gear shaft 20 is driven to slide. Alternatively, the displacement driving unit 30 may be a pneumatic cylinder or an electromagnetic device, and the slide gear shaft 20 is pneumatically or electromagnetically driven to slide.

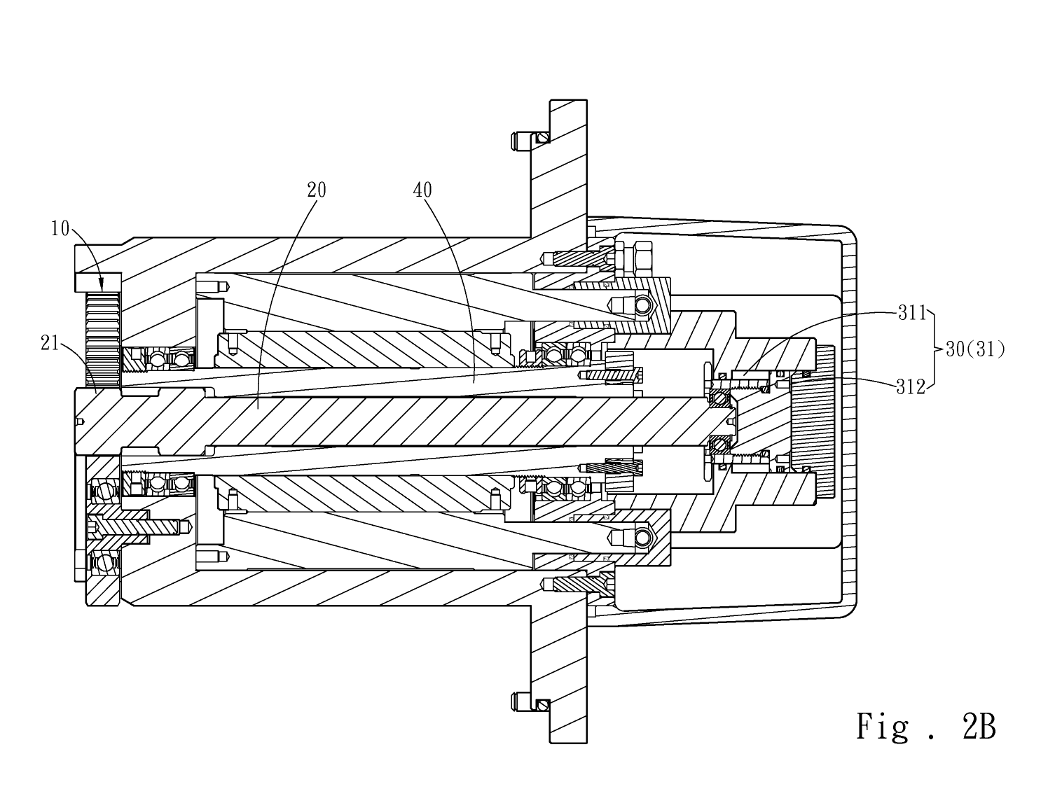

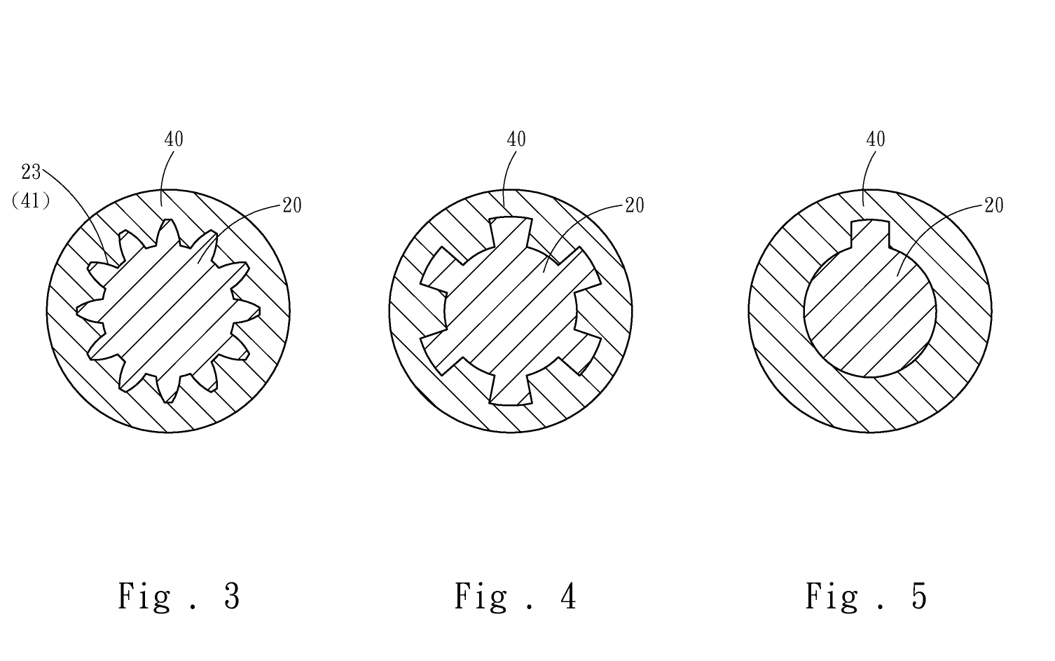

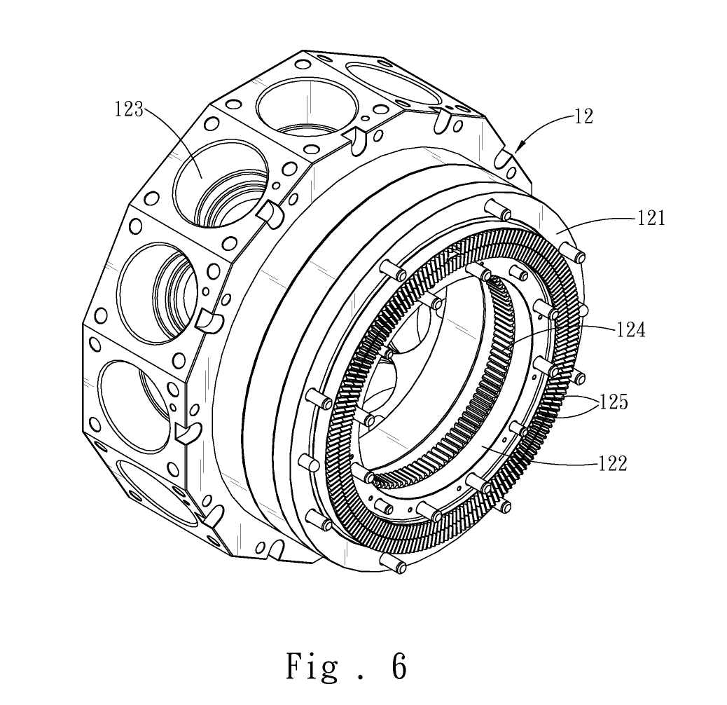

The transmission spindle 40 is arranged around the slide gear shaft 20 to form an internal motor. Alternatively, the transmission spindle 40 may be coupled to an external motor, and the external motor drives the transmission spindle 40 to rotate, and the transmission spindle 40 further drives the slide gear shaft 20 to rotate. Refer to FIG. 3, FIG. 4 and FIG. 5. The transmission spindle 40 is a hollow structure having an inner gear 41. The slide gear shaft 20 has an outer gear 23 corresponding to the inner gear 41. Via the engagement of the inner gear 41 and the outer gear 23, dynamic power is transmitted from the transmission spindle 40 to the slide gear shaft 20. The engagement of the transmission spindle 40 and the slide gear shaft 20 may also be realized with a six-wedge mechanism (as shown in FIG. 4) or a single-bayonet mechanism (as shown in FIG. 5).

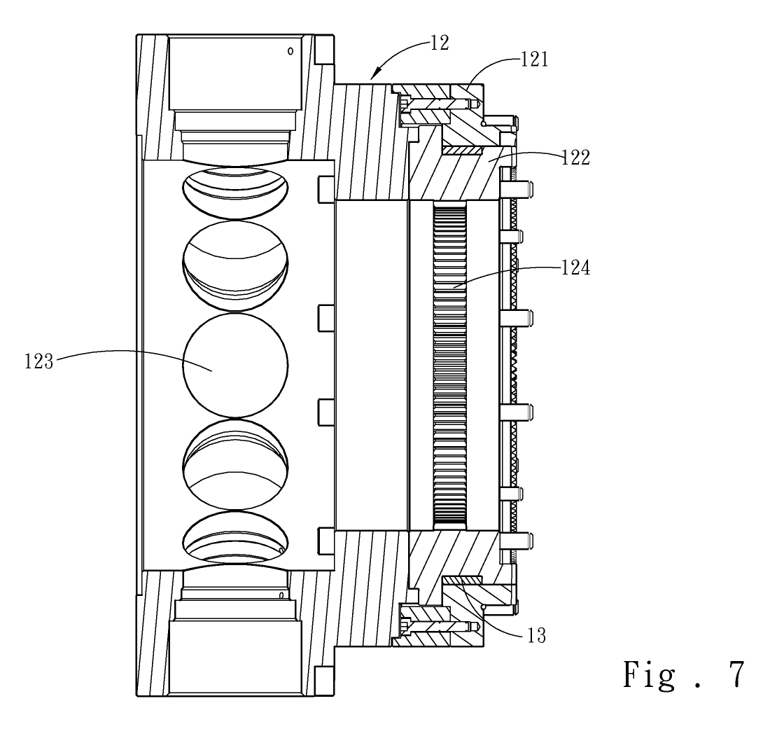

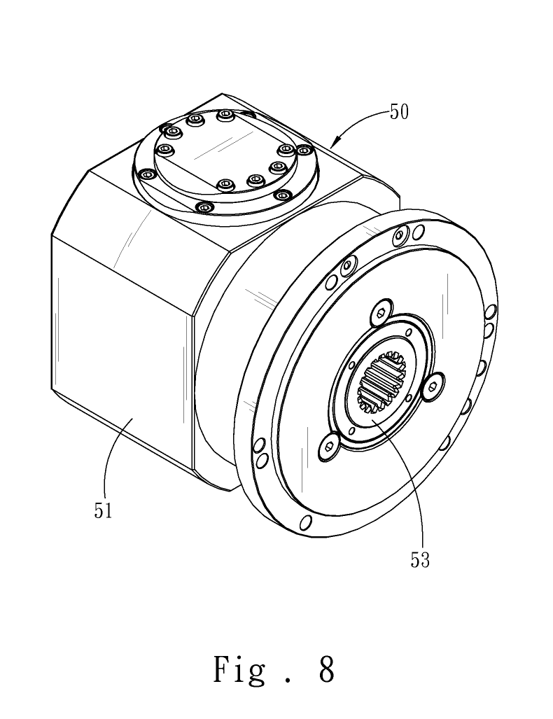

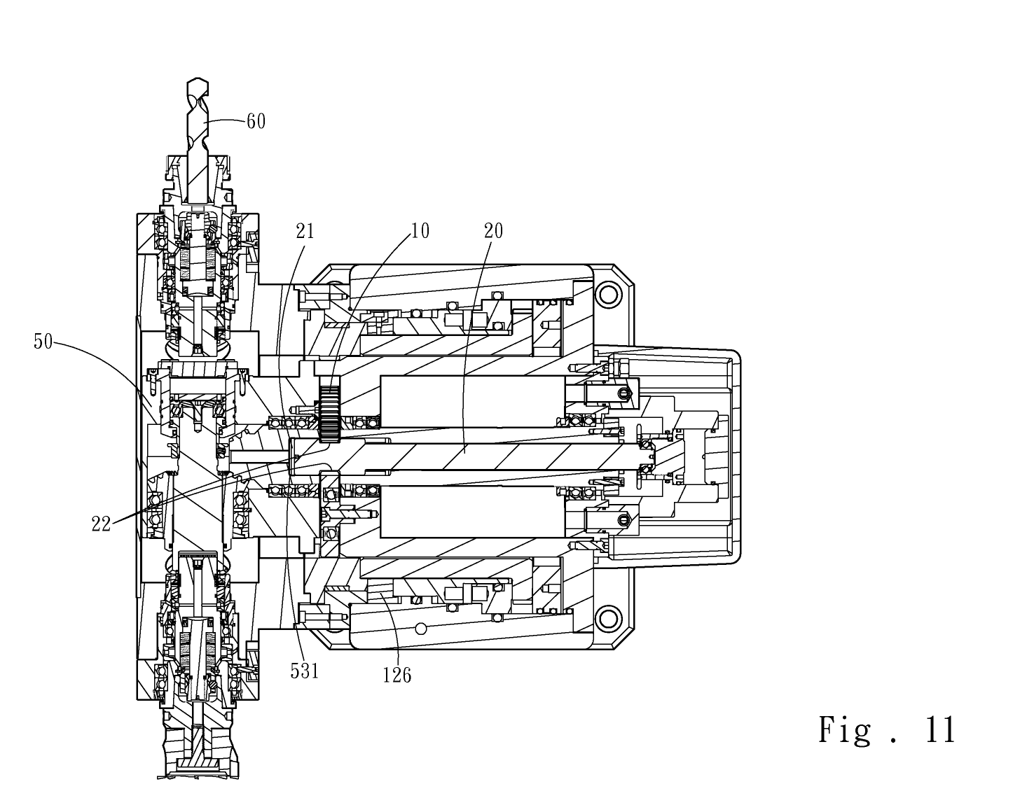

Refer to FIG. 6 and FIG. 7. The deceleration gear assembly 10 is a planetary gear assembly 11 engaging with a rotational wheel device 12. The rotational wheel device 12 has a static wheel 121 and a rotary wheel 122. The static wheel 121 sleeves the rotary wheel 122, and a bearing 13 interposes between the static wheel 121 and the rotary wheel 122. The rotary wheel 122 has a plurality of installation holes 123 and an internal annular gear 124. The internal annular gear 124 engages with the planetary gear assembly 11. The edges of the static wheel 121 and the rotary wheel 122 respectively have fixing trenches 125 matching each other. A fastening element 126 (as shown in FIG. 11) is press-fitted to the fixing trenches 125 to fix the relative position of the static wheel 121 and the rotary wheel 122.

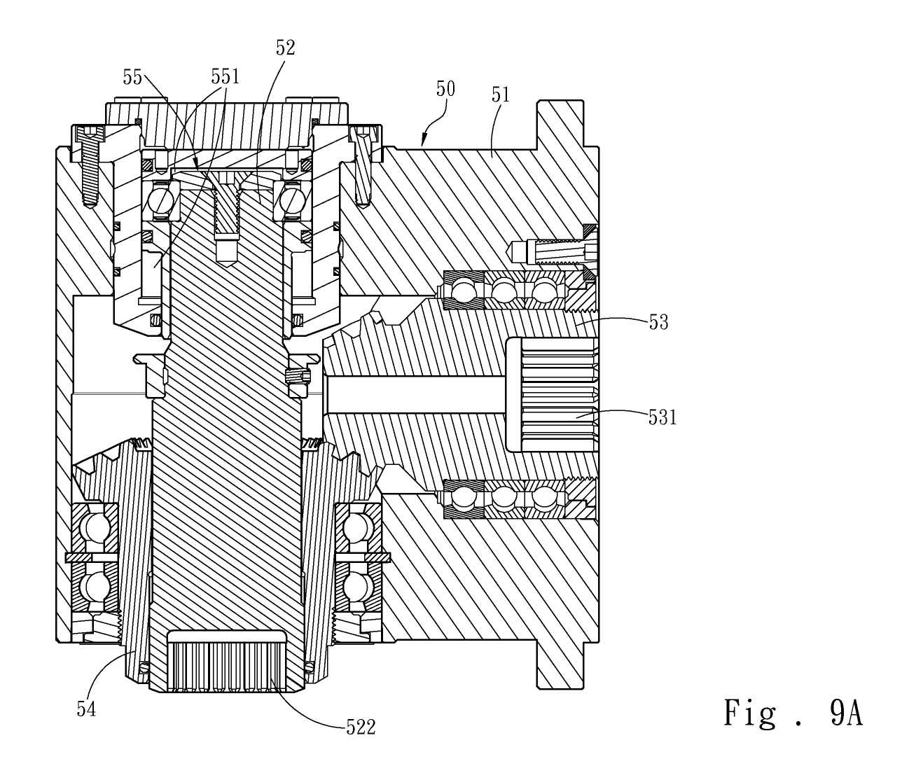

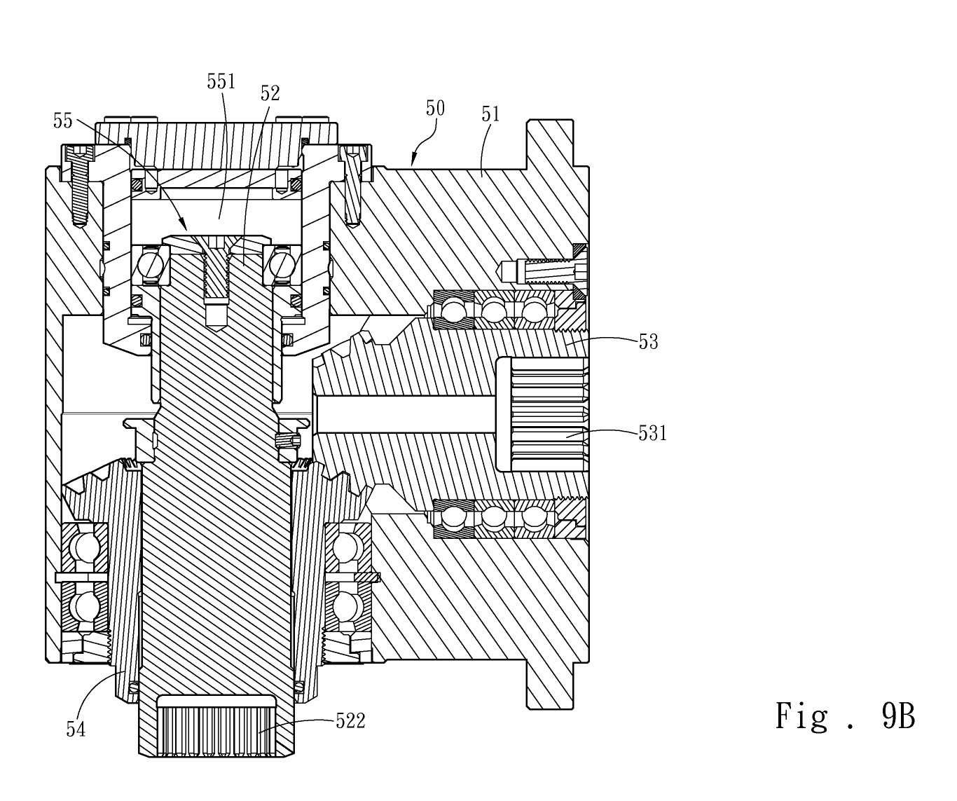

Refer to FIG. 8, FIG. 9A and FIG. 9B. A spindle connector 50 has a bevel gear seat 51, a slide connection rod 52, a bevel gear shaft 53 and a bevel gear 54. The bevel gear 54 and the bevel gear shaft 53 are rotatably installed inside the bevel gear seat 51, and engaged to each other by different directions of transmission. The bevel gear shaft 53 has an inner gear 53 1 engaging with the gear 21. The bevel gear 54 sleeves the slide connection rod 52 and rotates synchronously with the slide connection rod 52. The slide connection rod 52 slidably contacts the bevel gear seat 51. A displacement driving unit 55 drives the slide connection rod 52 to slide. The edge of the slide connection rod 52 has an inner transmission gear 522. The displacement driving unit 55 is a hydraulic unit, and liquid is injected to a chamber 551 to drive the slide connection rod 52 to slide (as shown in FIG. 9B).

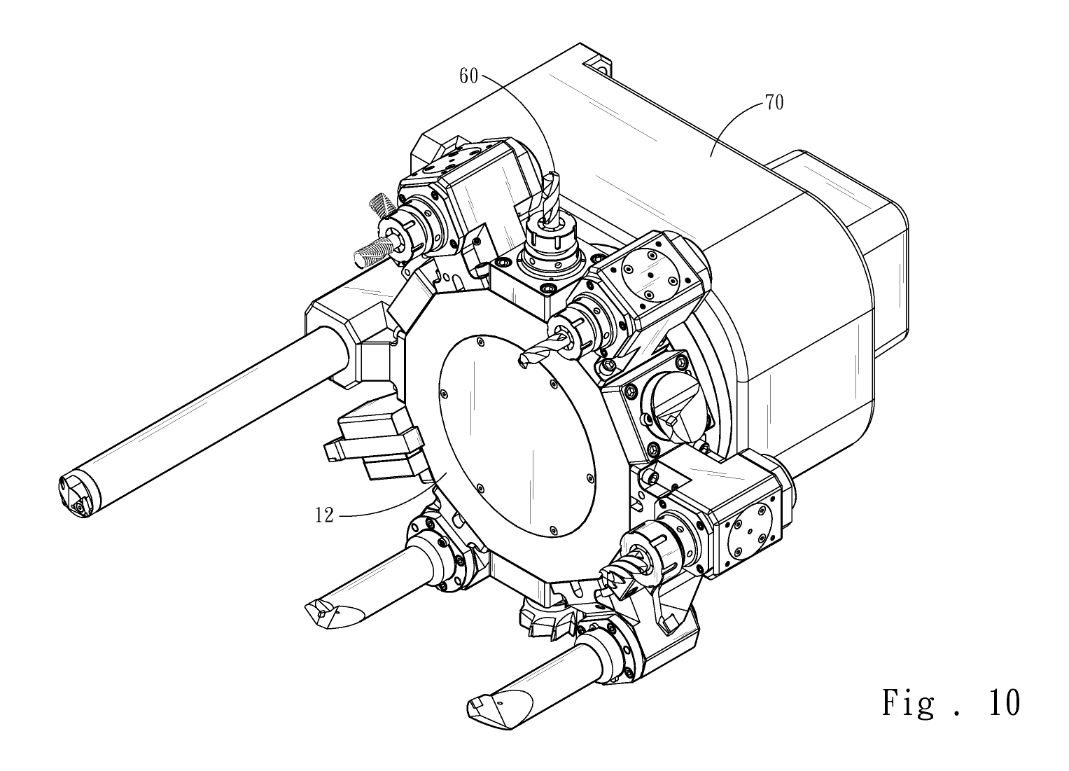

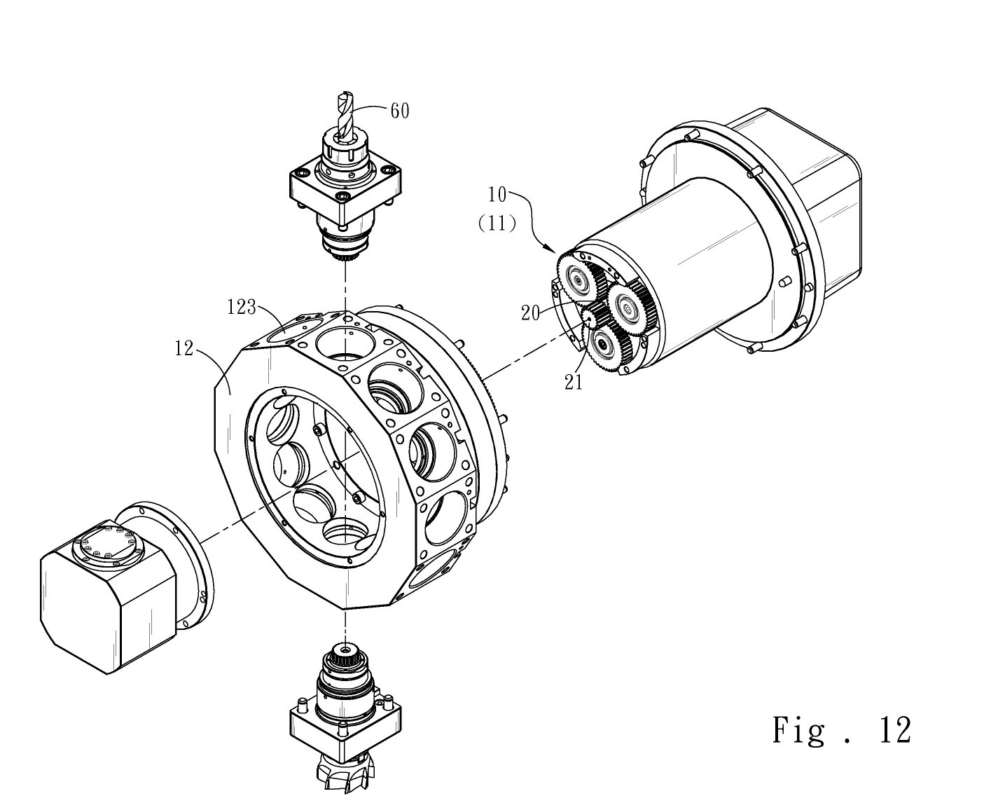

Refer to FIG. 10, FIG. 11 and FIG. 12. FIG. 10 is a perspective view schematically showing the installation of cutting tools 60 and a casing 70. The gear 21 is arranged in the terminal of the slide gear shaft 20. The spindle connector 50 has the inner gear 531 exactly facing the terminal of the slide gear shaft 20. The circumference of the slide gear shaft 20 has an annular trench 22. The deceleration gear assembly 10 is arranged around the slide gear shaft 20. When the slide gear shaft 20 slides to the first position, the gear 21 engages with the inner gear 531 of the spindle connector 50, and the deceleration gear assembly 10 is located in the annular trench 22. When the slide gear shaft 20 slides to the second position, the gear 21 withdraws from the inner gear 531 of the spindle connector 50 and engages with the deceleration gear assembly 10.

In conclusion, the present invention uses a single motor to provide dynamic power for the rotation of the shaft and the shifting of the cutting seats. Further, the present invention uses a novel transmission structure to stably transmit dynamic power and promote the stability of the machine. Therefore, the present invention can greatly reduce the volume and cost of a machine and effectively promote the machining quality thereof.

What is claimed is:

1. A deceleration device for a power turret clutch comprising
a deceleration gear assembly;
a slide gear shaft having a gear;
a displacement driving unit driving said slide gear shaft to slide axially to a first position and a second position, wherein said slide gear shaft engages with a spindle connector at said first position; said slide gear shaft withdraws from said spindle connector and engages with said deceleration gear assembly at said second position;
a transmission spindle driving said slide gear shaft to rotate and providing dynamic power for said slide gear shaft.

2. The deceleration device for a power turret clutch according to claim 1, wherein said deceleration gear assembly is a planetary gear assembly engaging with a rotational wheel device.

3. The deceleration device for a power turret clutch according to claim 2, wherein said rotational wheel device has a static wheel and a rotary wheel; said static wheel sleeves said rotary wheel, and a bearing interposes between said static wheel and said rotary wheel; said rotary wheel has a plurality of installation holes and an internal annular gear engaging with said planetary gear assembly.

4. The deceleration device for a power turret clutch according to claim 3, wherein edges of said static wheel and said rotary wheel respectively have fixing trenches matching each other; a fastening element is press-fitted to said fixing trenches to fix a relative position of said static wheel and said rotary wheel.

5. The deceleration device for a power turret clutch according to claim 1, wherein said gear is arranged in a terminal of said slide gear shaft; said spindle connector has an inner gear exactly facing said terminal of said slide gear shaft; a circumference of said slide gear shaft has an annular trench; said deceleration gear assembly is arranged around said slide gear shaft; when said slide gear shaft slides to said first position, said gear engages with said inner gear and said deceleration gear assembly is located in said annular trench; when said slide gear shaft slides to said second position, said gear withdraws from said inner gear and engages with said deceleration gear assembly.

6. The deceleration device for a power turret clutch according to claim 1, wherein said displacement driving unit is a hydraulic unit having a first chamber and a second chamber; when liquid is respectively injected into said first chamber and said second chamber, said slide gear shaft is driven to slide.

7. The deceleration device for a power turret clutch according to claim 1, wherein said displacement driving unit is selected from a pneumatic cylinder or an electromagnetic device, and said slide gear shaft is pneumatically or electromagnetically driven to slide.

8. The deceleration device for a power turret clutch according to claim 1, wherein said transmission spindle is arranged around said slide gear shaft to form an internal motor.

9. The deceleration device for a power turret clutch according to claim 1, wherein said spindle connector has a bevel gear seat, a slide connection rod, a bevel gear shaft and a bevel gear; said bevel gear and said bevel gear shaft are rotatably installed inside said bevel gear seat, and engaged to each other by different directions of transmission; said bevel gear shaft has an inner gear engaging with said gear; said bevel gear sleeves said slide connection rod and rotates synchronously with said slide connection rod; said slide connection rod slidably contacts said bevel gear seat; another displacement driving unit drives said slide connection rod to slide; an edge of said slide connection rod has an inner transmission gear.
